(19) United States
(12) Patent Application Publication
(10) Pub. No.: US 2015/0093320 A1
(43) Pub. Date: Apr. 2, 2015

(54) CARBON PRECURSOR COMPOSITION

(71) Applicant: Dow Global Technologies LLC, Midland, MI (US)

(72) Inventors: Hamed H. Lakrout, Lake Jackson, TX (US); Maurice J. Marks, Lake Jackson, TX (US); Ludovic Valette, Perrysburg, OH (US)

(21) Appl. No.: 14/391,721

(22) PCT Filed: May 17, 2013
(86) PCT No.: PCT/US2013/041567

§ 371 Date: Oct. 10, 2014

Related U.S. Application Data
(60) Provisional application No. 61/657,964, filed on Jun. 11, 2012.

(51) Int. Cl. C08G 59/24; C08G 59/50; C01B 31/02; C08G 59/62

(52) U.S. Cl. CPC C08G 59/245; C08G 59/621; C08G 59/504; C01B 31/02
USPC 423/445 R; 528/418; 525/524; 523/400

(57) ABSTRACT

A liquid carbon precursor composition including (a) at least one aromatic epoxy resin; and (b)(i) at least one aromatic co-reactive curing agent or (b)(ii) at least one catalytic curing agent, or (b)(iii) a mixture thereof; wherein the liquid composition prior to adding optional components and curing, has a neat viscosity of less than 10,000 mPa-s, at 25° C.; and wherein the liquid precursor composition has a neat viscosity of less than 10,000 mPa-s at 25° C. prior to adding optional components, prior to curing, and prior to carbonizing; and wherein the liquid precursor composition being cured has a carbon yield of at least 35 weight percent as measured in the absence of optional components; a cured liquid carbon precursor composition; a carbonized material made from the above liquid carbon precursor composition; and processes for producing the above compositions.

### FIELD

The present invention is related to a liquid carbon precursor formulation or composition and a process for preparing the liquid carbon precursor composition.

### BACKGROUND

Heretofore, several processes have been disclosed for preparing various carbonized end products from carbonaceous precursor materials. The known processes for preparing carbonized end products are generally carried out by the steps of:

(i) introducing, for example by impregnation or infiltration, a liquid carbon precursor into the pores of a porous object or preform (e.g., a carbon reinforcing material such as a bundle of carbon fibers) to form an impregnated preform, (ii) solidifying (e.g., by curing to form a thermoset) the liquid carbon precursor impregnated preform to form a solidified preform, and (iii) carbonizing the solidified preform to form a carbonized end product.

For example, GB1343773A discloses graphite articles reinforced with carbon fibres prepared by impregnating a bundle of aligned carbon fibres with a liquid containing a thermosetting resin such as an epoxy resin. The liquid disclosed in GB1343773A has a viscosity that increases with time and temperature; and thus, as the viscosity of the epoxy thermosetting resin increases, the amount of epoxy resin pick-up in the fibres is further restricted. In addition, when using an epoxy resin thermosetting resin in a liquid precursor for impregnating carbon fibers, the final carbonized product made from such liquid epoxy resin precursor has a very low carbon yield, for example a carbon yield of less than 20 weight percent (wt %).

James Gary Pruett, “Carbon Matrices”, ASM Handbook, Volume 21, Composites, Miracle et al., editors, p 164-168, 2001; describes very well the problem with known liquid precursors for forming a carbon matrix as follows:
“All liquid precursor methods for producing a carbon matrix suffer from one problem: the precursor materials always have a lower carbon content per unit volume than does the desired carbon matrix. Therefore, there is always a reduction in volume of the precursor when going to the final matrix. In addition, most of the liquid precursor materials lose some of their carbon content and all of their noncarbon content during the carbonization process. . . . As a result, a high premium is placed on carbon yield in the process. Poor carbon yields are obtained from polyesters and epoxides (<20%). Useful yields are obtained from epoxy-novalac, furan, and phenol formaldehyde resins (>50%).”

The Pruett reference above discloses an epoxy-novolac providing carbon yields of >50%; but, epoxy-novolac resins suffer from the disadvantage of being very viscous. The viscosity of the epoxy-novolac disclosed in Pruett can be so high (e.g., 30,000 mPa-s at 25° C.) that such epoxy-novolac resin is difficult to process by coating, filming, infusing, spraying, and impregnating. Thus, the viscous epoxy-novolac resin requires a solvent to reduce the resin's viscosity to be able to process the resin by the above methods. However, solvents tend to reduce the effective carbon yield of the resulting product made from the solvent-diluted resin formulation.

### SUMMARY

One embodiment of the present invention is directed to a liquid carbon precursor composition useful as a precursor for producing other carbon materials, wherein the liquid carbon precursor composition includes (a) at least one aromatic epoxy resin; and (b)(i) at least one aromatic co-reactive curing agent, or (b)(ii) at least one catalytic curing agent, or (b)(iii) a mixture thereof; wherein the liquid precursor composition has a neat viscosity of less than 10,000 mPa-s at 25° C. prior to adding optional components, prior to curing, and prior to carbonizing; and wherein the liquid precursor composition being cured has a carbon yield of at least 35 wt % as measured in the absence of optional components.

Another embodiment of the present invention is directed to a process for preparing the above liquid carbon precursor composition.

Still another embodiment of the present invention is directed to a cured carbon precursor composition including a reaction product of curing a curable liquid formulation comprising: (a) at least one aromatic epoxy resin; and (b)(i) at least one aromatic co-reactive curing agent, (b)(ii) at least one catalytic curing agent, or (b)(iii) a mixture thereof; and (c) at least one porogen; wherein the liquid composition has a neat viscosity of less than 10,000 mPa-s, at 25° C. prior to adding optional components, prior to curing, and prior to carbonizing; and wherein the cured carbon precursor composition has a carbon yield of at least 35 weight percent as measured in the absence of optional components.

Yet another embodiment of the present invention is directed to a process for preparing the above cured liquid carbon precursor composition.

Still another embodiment of the present invention is directed to a carbonized product prepared by curing and carbonizing the above liquid carbon precursor composition.

Yet another embodiment of the present invention is directed to a process for preparing a carbonized product comprising the steps of:

(I) admixing (a) at least one aromatic epoxy resin; and (b)(i) at least one aromatic co-reactive curing agent, or (b)(ii) at least one catalytic curing agent, or (b)(iii) a mixture thereof; wherein the liquid precursor composition has a neat viscosity of less than 10,000 mPa-s at 25° C. prior to adding optional components, prior to curing, and prior to carbonizing; and wherein the liquid precursor composition being cured has a carbon yield of at least 35 wt % as measured in the absence of optional components;

(II) curing the curable liquid carbon precursor composition from step (I) to form a cured product; wherein the cured composition has a carbon yield of at least 35 weight percent as measured in the absence of optional components; and

(III) carbonizing the cured product from step (II) to form a carbonized composition.

A carbonized composition prepared from the above liquid carbon precursor composition of the present invention using the above process may be advantageously useful in various enduse carbonized products containing said carbonized composition such as for example a carbon-carbon composite article or part.

In addition, when producing a carbonized end product for enduses such as described above, the carbonizable liquid carbon precursor composition, prior to its curing, exhibits a low neat viscosity that allows the liquid precursor to flow and adequately wet carbon materials (such as carbon fibers or carbon mats) that are used in combination with the liquid precursor in various enduses. For example, upon curing and carbonizing a combination of a liquid carbon precursor composition/carbon material, the resultant carbonized product has a higher carbon density than the starting carbon material; and the carbon density of the resultant carbonized product is sufficiently increased to a level sufficient for its intended enduse.

A carbon precursor composition capable of providing certain increased properties to the final carbonized product such as the thermal conductivity and/or the structural strength (such as maximum compressibility) of the carbonized product part would be desirable to the skilled artisan. Also, in some applications it is desirable for the carbon precursor composition to be capable of being disperse efficiently and uniformly throughout another carbon material (such as a bundle of carbon fibers or a carbon fiber mat) such that non-uniformities or inhomogeneities in the final carbonized product is decreased or minimized such that the reliability of the part made from the final carbonized product is increased because of the more consistent volumetric properties.

One objective of the present invention is to provide a rapid low-cost highly efficient process for manufacturing thick high-performance carbon composites in the form of uniformly densified shaped structures having a high carbon yield by impregnating a carbon matrix with a low-viscosity wetting liquid carbon precursor composition which can undergo curing and carbonization to ultimately produce a carbonized matrix.

Advantageously, the low viscosity liquid carbon precursor composition of the present invention can wet a variety of carbon materials such as carbon fibers; and the liquid carbon precursor composition can easily impregnate even the smallest pores of a carbon matrix. Once inside the carbon matrix, curing the liquid carbon precursor composition inside the carbon matrix is initiated resulting in a cured precursor which in turn can be carbonized to form a superior matrix.

In addition, low viscosity liquid carbon precursor composition of the present invention provides unexpected and surprising results that are contrary to the prior art. For example, U.S. Pat. No. 6,309,703 in column 4, lines 14-19, teaches the following:
“As with rigid-preform formation, the goal of attaining composite performance as high as possible presents a dilemma: use low-viscosity liquid matrix-precursors and obtain good impregnation, but poor pyrolysis efficiencies; or use high-viscosity liquid matrix precursors and obtain poor impregnation but high pyrolysis efficiencies.”

U.S. Pat. No. 6,309,703, in column 4, lines 14-19, explains why high molecular weight polymers (i.e., high viscosity liquid matrix-precursors) are better than low molecular weight polymers (i.e., low-viscosity liquid matrix precursors) as follows:
“The fundamental chemical characteristic common to both liquid binders and liquid matrix-precursors used in all carbon and some ceramic matrix composites is that they are polymers. This fact explains why low-viscosity binders and precursors have low pyrolysis efficiencies and produce poor-quality matrices. In order to have low viscosity, polymers must possess a limited number of repeat units, otherwise entanglements between polymer chains occur during fluid flow limiting mass transport. During matrix formation by pyrolysis, the desired reaction is the loss of certain light constituents atoms, such as hydrogen, from polymer repeat units with no cleavage taking place between repeat units at all. However, in practice there is always unwanted but unavoidable side reactions in which there is the complete cleavage of individual repeat units off the ends of the polymer molecules thereby forming higher-molecular-weight gases. Since chain ends break off in cyclic fashion (i.e., one after another in rapid succession), pyrolysis yields are much lower in low-molecular-weight polymers than in high-molecular-weight polymers. High-molecular-weight polymers simply have far fewer chain ends to begin with, so there is much less end-breakage and associate gas evolution during pyrolysis. Gas evolution is detrimental because it pushes liquid matrix-precursor out of rigid-preforms before matrix formation by pyrolysis takes place and reduces the pyrolysis yield.”

Therefore, in accordance with the present invention, a liquid carbon precursor composition exhibiting a low neat viscosity is provided. The low viscosity liquid precursor, prior to being cured and carbonized, is capable of flowing and adequately wetting carbon materials (such as carbon fibers or carbon mats); while at the same time, upon being cured and carbonized, is capable of producing a high carbon yield (e.g. a carbon yield of at least 35 wt % and greater) contrary to the prior art.

### BRIEF DESCRIPTION OF THE DRAWINGS

For the purpose of illustrating the present invention, the drawings show a form of the present invention which is presently preferred. However, it should be understood that the present invention is not limited to the specific embodiments shown in the drawings.

FIG. 1 is a graphical illustration showing the evolution of weight versus temperature of the cured formulation of the present invention compared to cured formulations of the prior art.

FIG. 2 is a photograph of a liquid droplet of a liquid carbon precursor composition of the present invention.

### DETAILED DESCRIPTION

In its broadest scope, the present invention is directed to a curable liquid carbon precursor composition comprising (a) at least one aromatic epoxy resin; and (b)(i) at least one aromatic co-reactive curing agent, (b)(ii) at least one catalytic curing agent, or (b)(iii) a mixture thereof; wherein the liquid precursor composition has a neat viscosity of less than 10,000 mPa-s at 25° C. prior to adding optional components, prior to curing, and prior to carbonizing; and wherein the liquid precursor composition being cured has a carbon yield of at least 35 wt % as measured in the absence of optional components.

“Carbonizing”, “carbonization” or “pyrolyzing” herein means removing a significant portion of non-carbon elements from a composition by heating the composition at a temperature of 10° C./minute from 25° C. to 1,000° C. under an inert atmosphere such as nitrogen.

“Carbon yield” with reference to a cured composition herein means the percent weight remaining from a cured sample of a composition treated at 10° C./minute from 25° C. to 1,000° C. under an inert atmosphere such as nitrogen as measured in the absence of optional components.

The aromatic epoxy resin compound, component (a), useful in the present invention curable liquid carbon precursor composition can be one aromatic epoxy resin or a combination of two or more epoxy resin compounds, wherein at least one of the epoxy resin compounds is an aromatic epoxy resin. For example, one preferred embodiment of the aromatic epoxy resin useful in the present invention may be a divinylarene dioxide.

In one embodiment, the divinylarene dioxide useful in the curable liquid carbon precursor composition of the present invention may include any of the divinylarene dioxides described in U.S. patent application Ser. No. 13/133,510.

In another embodiment, the divinylarene dioxide useful in preparing the curable liquid carbon precursor composition of the present invention may include, for example, any substituted or unsubstituted arene nucleus bearing one or more vinyl groups in any ring position. For example, the arene portion of the divinylarene dioxide may consist of benzene, substituted benzenes, (substituted) ring-annulated benzenes or homologously bonded (substituted) benzenes, or mixtures thereof. The divinylbenzene portion of the divinylarene dioxide may be ortho, meta, or para isomers or any mixture thereof. Additional substituents may consist of H₂O₂-resistant groups including saturated alkyl, aryl, halogen, nitro, isocyanate, or RO— (where R may be a saturated alkyl or aryl). Ring-annulated benzenes may consist of naphthalene, and tetrahydronaphthalene. Homologously bonded (substituted) benzenes may consist of biphenyl, and diphenylether.

The divinylarene dioxide used for preparing the formulations of the present invention may be illustrated generally by chemical Structures I-IV as follows:

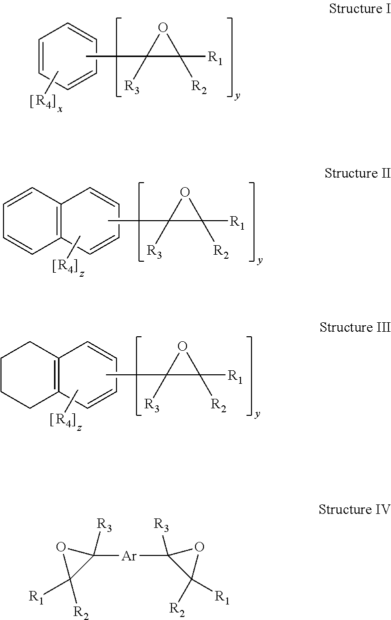

In the above Structures I, II, III, and W of the divinylarene dioxide useful in the present invention, each R₁, R₂, R₃ and R₄ individually may be hydrogen, an alkyl, cycloalkyl, an aryl or an aralkyl group; or a H₂O₂-resistant group including for example a halogen, a nitro, an isocyanate, or an RO group, wherein R may be an alkyl, aryl or aralkyl; x may be an integer of 0 to 4; y may be an integer greater than or equal to 2; x+y may be an integer less than or equal to 6; z may be an integer of 0 to 6; and z+y may be an integer less than or equal to 8; and Ar is an arene fragment including for example, 1,3-phenylene group. In addition, R4 can be a reactive group(s) including epoxide, isocyanate, or any reactive group and Z can be an integer from 0 to 6 depending on the substitution pattern.

In one embodiment, the divinylarene dioxide useful in the present invention may be produced, for example, by the process described in U.S. Patent Provisional Application Ser. No. 61/141,457, filed Dec. 30, 2008, by Marks et al., incorporated herein by reference. In another embodiment, the divinylarene dioxides useful in the present invention are disclosed in, for example, U.S. Pat. No. 2,924,580, incorporated herein by reference.

In still another embodiment, the divinylarene dioxide useful in the present invention may include, for example, divinylbenzene dioxide (DVBDO), divinylnaphthalene dioxide, divinylbiphenyl dioxide, divinyldiphenylether dioxide, or mixtures thereof.

In one preferred embodiment of the present invention, the divinylarene dioxide used in the curable liquid carbon precursor composition of the present invention can be for example DVBDO. Divinylarene dioxides such as for example DVBDO are a class of diepoxides which have a relatively low liquid viscosity but a higher rigidity and crosslink density than conventional epoxy resins.

In another preferred embodiment, the divinylarene dioxide compound useful in the present invention includes, for example, a DVBDO as illustrated by the following chemical formula of Structure V:

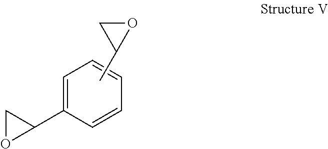

The chemical formula of the above DVBDO compound may be as follows: C₁₀H₁₀O₂; the molecular weight of the DVBDO is 162.2; and the elemental analysis of the DVBDO is: C, 74.06; H, 6.21; and O, 19.73 with an epoxide equivalent weight of 81 g/mol.

Structure VI below illustrates another embodiment of a preferred chemical structure of the DVBDO useful in the present invention:

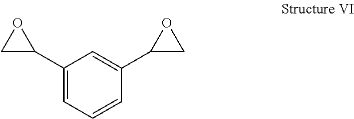 [SMILES: c1cc(C2CO2)cc(C2CO2)c1]

Structure VII below illustrates still another embodiment of a preferred chemical structure of the DVBDO useful in the present invention:

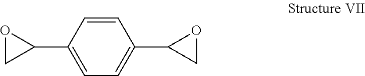 [SMILES: c1cc(C2CO2)ccc1C1CO1]

When DVBDO is prepared by the processes known in the art, it is possible to obtain one of three possible isomers: ortho, meta, and para. Accordingly, the present invention includes a DVBDO illustrated by any one of the above Structures individually or as a mixture thereof. Structures VI and VII above show the meta (1,3-DVBDO) isomer and the para (1,4-DVBDO) isomer of DVBDO, respectively. The ortho isomer is rare; and usually DVBDO is mostly produced generally in a range of from 9:1 to 1:9 ratio of meta (Structure VI) to para (Structure VII) isomers. The present invention preferably includes as one embodiment a range of from 6:1 to 1:6 ratio of Structure VI to Structure VII, and in other embodiments the ratio of Structure VI to Structure VII may be from 4:1 to 1:4 or from 2:1 to 1:2.

In yet another embodiment of the present invention, the divinylarene dioxide may contain quantities (such as for example less than 20 wt %) of substituted arenes and/or arene oxides. The amount and structure of the substituted arenes and/or arene oxides mixed with a divinylarene dioxide composition depends on the process used in the preparation of the divinylarene precursor which is, in turn, used to prepare the divinylarene dioxide. For example, the divinylarene precursor such as divinylbenzene (DVB) can be prepared by the dehydrogenation of diethylbenzene (DEB), and the resultant product composition may contain quantities of ethylvinylbenzene (EVB) and DEB. During the dehydrogenation reaction of DEB, wherein an oxidant such as hydrogen peroxide, the EVB present in the reaction mixture can react with hydrogen peroxide to produce ethylvinylbenzene oxide while DEB remains unchanged. The presence of ethylvinylbenzene oxide and DEB in the divinylarene dioxide can increase the epoxide equivalent weight of the divinylarene dioxide to a value greater than that of a pure divinylarene dioxide compound.

In one embodiment, the divinylarene dioxide, (for example DVBDO) useful in the present invention comprises a low viscosity liquid epoxy resin. For example, the viscosity of the divinylarene dioxide used in the present invention ranges generally from 0.001 Pa-s to 0.1 Pa-s in one embodiment, from 0.01 Pa-s to 0.05 Pa-s in another embodiment, and from 0.01 Pa-s to 0.025 Pa-s in still another embodiment, at 25° C.

One advantageous property of the divinylarene dioxide useful in the present invention is its rigidity. The rigidity property of the divinylarene dioxide is measured by a calculated number of rotational degrees of freedom of the dioxide excluding side chains using the method of Bicerano described in Prediction of Polymer Properties, Dekker, New York, 1993. The rigidity of the divinylarene dioxide used in the present invention may range generally from 6 to 10 rotational degrees of freedom in one embodiment, from 6 to 9 rotational degrees of freedom in another embodiment, and from 6 to 8 rotational degrees of freedom in still another embodiment.

The aromatic epoxy resin useful in the present invention curable liquid carbon precursor composition may include a wide variety of aromatic epoxy resins known in the art other than the divinylarene dioxide. The aromatic epoxy resin may be may be substituted or unsubstituted. The aromatic epoxy resin may be monomeric or polymeric. The aromatic epoxy resin may include a single aromatic epoxy resin or may include a combination of two or more aromatic epoxy resins.

For example, the aromatic epoxy resin useful in the present invention may include, one or more aromatic epoxy resin compounds described in Pham, H. Q. and Marks, M. J., Epoxy Resins, the Kirk-Othmer Encyclopedia of Chemical Technology; John Wiley & Sons, Inc.: online Dec. 4, 2004 and in the references therein; in Lee, H. and Neville, K., Handbook of Epoxy Resins, McGraw-Hill Book Company, New York, 1967, Chapter 2, pages 2-1 to 2-33, and in the references therein; May, C. A. Ed., Epoxy Resins: Chemistry and Technology, Marcel Dekker Inc.: New York, 1988 and in the references therein; and in U.S. Pat. No. 3,117,099; all of which are incorporated herein by reference.

Some of the aromatic epoxy resin compounds useful in the present invention include for example epoxy compounds based on reaction products of polyfunctional phenols, aromatic amines, or aminophenols with epichlorohydrin. A few non-limiting embodiments include, for example, bisphenol A diglycidyl ether, bisphenol F diglycidyl ether, resorcinol diglycidyl ether, and triglycidyl ethers of p-aminophenols. Other suitable epoxy compounds known in the art include for example reaction products of epichlorohydrin with o-cresol novolacs, hydrocarbon novolacs, and, phenol novolacs. The epoxy compound may also be selected from commercially available products such as for example, D.E.R. 331®, D.E.R. 332, D.E.R. 354, D.E.R. 580, D.E.N. 425, D.E.N. 431, or D.E.N. 438 epoxy resins available from The Dow Chemical Company.

As aforementioned, the curable liquid carbon precursor composition can be prepared by admixing the at least one aromatic epoxy resin described above with (b)(i) at least one aromatic co-reactive curing agent, or (b)(ii) at least one catalytic curing agent, or (b)(iii) a mixture of the at least one aromatic co-reactive curing agent and the at least one catalytic curing agent.

An “aromatic co-reactive curing agent” herein means an aromatic compound bearing functional groups which react with the epoxide of the aromatic epoxy resin to effect curing and/or polymerization by condensation of the epoxide groups of the aromatic epoxy resin with the functional groups of the aromatic co-reactive curing agent.

A “catalytic curing agent” herein means a compound which reacts with the epoxide group of the aromatic epoxy resin to initiate curing and/or polymerization of the aromatic epoxy resin by epoxide homopolymerization.

The at least one aromatic co-reactive curing agent or the at least one catalytic curing agent of the carbon precursor composition of the present invention can include for example one or a combination of two or more of the above curing agents. The aromatic co-reactive curing agent and the catalytic curing agent of the carbon precursor composition useful in the present invention may be selected from any aromatic co-reactive curing agents or any catalytic curing agents for epoxy resins known in the art.

For example, the aromatic co-reactive curing agent (also referred to as a hardener or cross-linking agent) useful in the present invention may be any aromatic compound having an active group being reactive with the reactive epoxy group of the epoxy resin. The chemistry of such curing agents is described in the previously referenced books on epoxy resins. The aromatic co-reactive curing agent useful in the present invention includes nitrogen-containing compounds such as amines and their derivatives; oxygen-containing compounds such as carboxylic acid terminated polyesters, anhydrides, phenol-formaldehyde resins, amino-formaldehyde resins, phenol, bisphenol A and cresol novolacs, and phenolic-terminated epoxy resins.

In one preferred embodiment, diaminodiphenylsulfone and their isomers, aminobenzoates, various acid anhydrides, phenol-novolac resins and cresol-novolac resins, for example, may be used in the present invention, but the present invention is not restricted to the use of these compounds.

The aromatic co-reactive curing agent of choice may depend on the aromatic epoxy resin used in the formulation. Generally, the aromatic co-reactive curing agent useful in the present invention may be selected from, for example, but are not limited to, phenols, benzoxazines, aromatic anhydrides, aromatic amines, aromatic carbodiimides, aromatic polyesters, aromatic polyisocyanates, and mixtures thereof. In the cases of a divinylarene dioxide used as the aromatic epoxy resin the aromatic co-reactive curing agent can also include a phenol, diphenol, or polyphenol.

In one embodiment, the at least one aromatic co-reactive curing agent may include one or more of aromatic amines such as methylenedianiline (MDA), toluenediamine (TDA), diethyltoluenediamine (DETDA), diaminodiphenylsulfone (DADS), polyphenols such as bisphenol A, bisphenol F, 1,1-bis(4-hydroxyphenyl)-ethane, hydroquinone, resorcinol, catechol, tetrabromobisphenol A, novolacs such as phenol novolac, bisphenol A novolac, hydroquinone novolac, resorcinol novolac, naphthol novolac, anhydrides such as phthalic anhydride, trimellitic anhydride, and mixtures thereof.

In a preferred embodiment, the aromatic co-reactive curing agent blended with the at least one aromatic epoxy resin such as for example a divinylarene dioxide in preparing the curable liquid carbon precursor composition of the present invention may comprise, for example, any compound adapted for providing a carbon yield of greater than 35 wt % when the compound is subjected to carbonization or pyrolysis. In one embodiment, the aromatic co-reactive curing agent adapted for providing a high carbon yield may include for example a phenol such as p-cresol or m-cresol or other phenol, and mixtures thereof. One preferred embodiment includes a phenol compound useful for the curable composition of the present invention, such as for example p-cresol.

Generally, the ratio r of epoxide equivalents from the aromatic epoxy resin to the co-reactive groups of the aromatic co-reactive curing agent adapted for providing a high carbon yield used in the present invention, may be for example, from 0.1 to 10 in one embodiment, from 0.2 to 8 in another embodiment; from 0.4 to 6 in still another embodiment; and from 1 to 5 in yet another embodiment. When r is greater than 1.0, after curing the excess epoxide may remain unreacted or may be reacted into the thermoset network. When the aromatic epoxy resin is a divinylarene dioxide and the aromatic co-reactive curing agent is a phenol, r is defined as explained in co-pending U.S. Provisional Patent Application No. 61/660,397.

The catalytic curing agent useful in the present invention may include, for example, Bronsted acids, Lewis acids, Lewis bases, alkali bases, Lewis acid-Lewis base complexes, quaternary ammonium compounds, quaternary phosphonium compounds, or mixtures thereof. Suitable examples of Bronsted acids include sulfuric acid, sulfonic acids, perchloric acid, phosphoric acid, partial esters of phosphoric acid, and mixtures thereof. One suitable example of a Lewis acid includes boron trifluoride. Suitable examples of Lewis bases include tertiary amines, imidazoles, amidines, substituted ureas and mixtures thereof. One suitable example of an alkali base includes potassium hydroxide. One suitable example of a Lewis acid-Lewis base complex includes boron trifluoride-ethylamine complex. One suitable example of a quaternary ammonium compound is benzyltrimethylammonium hydroxide. One suitable example of a quaternary phosphonium compound is tetrabutylphosphonium hydroxide.

In addition, when an aromatic epoxy resin such as a divinylarene dioxide is used, the catalytic curing agent useful in the present invention can include the latent catalysts described in co-pending U.S. Provisional Patent Application No. 61/660,403.

In preparing the curable liquid carbon precursor composition of the present invention, optional compounds can be added to the curable liquid carbon precursor composition including for example at least one curing catalyst. A “curing catalyst” or “cure catalyst” herein means a compound used to facilitate the reaction of the at least one aromatic epoxy resin with the aromatic co-reactive curing agent compound. The curing catalyst may be selected based on the epoxy resin employed and the aromatic co-reactive curing agent employed in the present invention composition.

In one illustrative embodiment when the epoxy resin is for example a divinylarene dioxide and the curing agent is for example a phenol, the optional curing catalyst useful in the present invention may include at least one acid compound-related cure catalyst to facilitate the reaction of the divinylarene dioxide compound with the phenol. In one embodiment, the catalyst useful in the present invention may include, for example, any one or more of the catalysts described in U.S. Provisional Patent Application Ser. No. 61/556,979, such as for example Bronsted acids (e.g., CYCAT® 600 commercially available from Cytec), Lewis acids, and mixtures thereof. In another embodiment, the catalysts may include for example a latent alkylating ester such as for example, any one or more of the catalysts described in WO 9518168.

In another embodiment, the latent alkylating ester cure catalyst may include for example the esters of sulfonic acids such as methyl p toluenesulfonate (MPTS), ethyl p-toluenesulfonate (EPTS), and methyl methanesulfonate (MMS); esters of α-halogenated carboxylic acids such as methyl trichloroacetate and methyl trifluoroacetate; and esters of phosphonic acids such as tetraethylmethylene-diphosphonate; or any combination thereof. One preferred embodiment of the cure catalyst used in the present invention may include for example MPTS. Other curing catalysts useful in the present invention may include for example those described in co-pending U.S. Provisional Patent Application No. 61/660,397.

Generally, the amount of catalytic curing agent or optional cure catalyst used in the present invention, may be for example, from 0.01 wt % to 20 wt % in one embodiment, from 0.1 wt % to 10 wt % in another embodiment; from 0.1 wt % to 5 wt % in still another embodiment; and from 0.1 wt % to 3 wt % catalyst in yet another embodiment. The use of lower levels of catalytic curing agent or optional cure catalyst would reduce reactivity and would result in less crosslinked network; and the use of higher levels of catalytic curing agent or optional cure catalyst would be uneconomical.

Other optional compounds that may be added to the curable liquid carbon precursor composition of the present invention may include compounds that are normally used in curable resin formulations known to those skilled in the art. For example, the optional components may comprise compounds that can be added to the composition to enhance application properties (e.g. surface tension modifiers or flow aids), reliability properties (e.g. adhesion promoters) the reaction rate, the selectivity of the reaction, and/or the catalyst lifetime.

Other optional compounds that may be added to the curable liquid carbon precursor composition of the present invention may include, for example, a solvent to lower the viscosity of the formulation even further from the initial viscosity of the composition; other epoxy resins different from the aromatic epoxy resin (e.g., aliphatic glycidyl ethers or cycloaliphatic epoxy resins); other curing agents different from aromatic co-reactive curing agents and catalytic curing agents; fillers; pigments; fibers; toughening agents; flow modifiers; adhesion promoters; diluents; stabilizers; plasticizers; curing catalysts; catalyst de-activators; flame retardants; coal tar pitch; petroleum pitch; aromatic hydrocarbon resins; carbon nanotubes; graphene; carbon black; carbon fibers, or mixtures thereof.

Generally, the amount of the other optional compounds, when used in the present invention, may be for example, from 0 wt % to 90 wt % in one embodiment, from 0.01 wt % to 80 wt % in another embodiment; from 0.1 wt % to 65 wt % in still another embodiment; and from 0.5 wt % to 50 wt % curing agent in yet another embodiment.

One embodiment of the present invention is directed to a process for preparing the above-described curable liquid carbon precursor composition which is a curable high carbon yield low neat viscosity resin formulation or composition. The process of preparing the curable liquid carbon precursor composition of the present invention includes the step of admixing (a) at least one aromatic epoxy resin; and (b)(i) at least one aromatic co-reactive curing agent, (b)(ii) at least one catalytic curing agent, or (b)(iii) a mixture thereof; and (c) optionally, at least one cure catalyst or other optional ingredients as desired. The liquid precursor composition has a neat viscosity of less than 10,000 mPa-s at 25° C. prior to adding optional components, prior to curing, and prior to carbonizing; and the liquid precursor composition advantageously upon being cured has a carbon yield of at least 35 wt % as measured in the absence of optional components by thermogravimetric analysis.

The compounds used in making the curable liquid carbon precursor composition are beneficially low viscosity materials that mix without special effort. For example, the preparation of the curable liquid carbon precursor composition of the present invention is easily achieved by blending the ingredients of the composition with a magnetic stir bar mixer or a pail mixer. For example, the curable liquid carbon precursor composition can be mixed with a standard pail mixer at from 1 rpm to 200 rpm.

The required and optional components or ingredients of the curable liquid carbon precursor composition or formulation of the present invention are typically mixed and dispersed at a temperature enabling the preparation of an effective curable composition having the desired balance of properties for a particular application. For example, the temperature during the mixing of the components may be generally from −10° C. to 100° C. in one embodiment, and from 0° C. to 50° C. in another embodiment. Lower mixing temperatures help to minimize reaction of the resin and hardener components to maximize the pot life of the formulation.

As one illustrative embodiment and not be limited thereby, a divinylbenzene dioxide, a p-cresol, a cure catalyst, and other desirable and optional additives, for example an additional epoxy resin, can be admixed together to form the curable liquid carbon precursor composition of the present invention.

The preparation of the curable liquid carbon precursor composition of the present invention, and/or any of the steps thereof, may be a batch or a continuous process. The mixing equipment used in the process may be any vessel and ancillary equipment well known to those skilled in the art.

The curable liquid carbon precursor composition of the present invention, prior to adding any optional compounds, prior to curing, and prior to carbonizing, has a neat viscosity of less than 10,000 mPa-s at 25° C. For example, the curable liquid carbon precursor composition without optional compounds and prior to curing and carbonizing has a neat viscosity of generally less than 10,000 mPa-s in one embodiment, from 1 mPa-s to 10,000 mPa-s in another embodiment, from 1 mPa-s to 5,000 mPa-s in yet another embodiment, from 5 mPa-s to 3,000 mPa-s in still another embodiment, and from 10 mPa-s to 1,000 mPa-s in yet another embodiment, at 25° C. In other embodiments, the neat viscosity of the curable liquid carbon precursor composition prior to curing can include 1 mPa-s or greater, 5 mPa-s or greater, or 10 mPa-s or greater. In other embodiments, the neat viscosity of the curable liquid carbon precursor composition prior to curing can include 10,000 mPa-s or lower, 5,000 mPa-s or lower, 3,000 mPa-s or lower or 1,000 mPa-s or lower.

One advantage of the low viscosity of the curable liquid carbon precursor composition of the present invention is that the low viscosity enables a processable amount of resin pick-up by the carbon matrix such as carbon fibers.

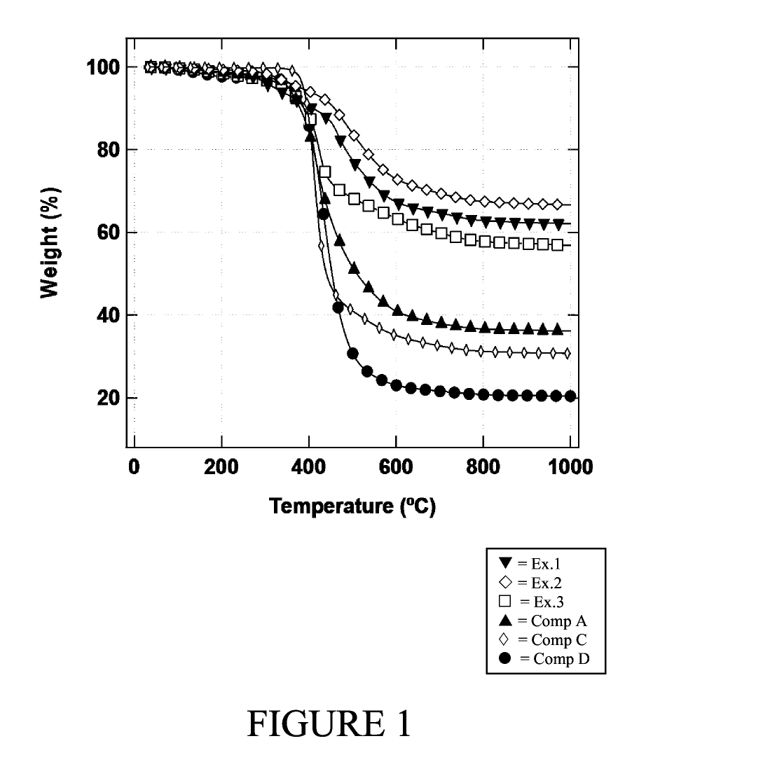

Also, using a curable liquid carbon precursor composition of the present invention that has a neat viscosity of less than 10,000 mPa-s prior to adding any optional compounds, prior to curing, and prior to carbonizing, provides a cured product having a high carbon yield as will be described with reference to FIG. 1.

In addition to having a low viscosity, the curable liquid carbon precursor composition, prior to curing, has a surface tension that can be from 10 mN/m to 70 mN/m at 25° C. in one embodiment, from 20 mN/m to 60 mN/m in another embodiment, and from 30 mN/m to 60 mN/m in still another embodiment. In other embodiments, the surface tension of the curable liquid carbon precursor composition prior to curing can include 10 mN/m or greater, 20 mN/m or greater, or 30 mN/m or greater. In other embodiments, the surface tension of the curable liquid carbon precursor composition prior to curing can include 70 mN/m or lower or 60 mN/m or lower.

Furthermore, the curable liquid carbon precursor composition of the present invention may have a wettability property sufficient to easily and efficiently wet the surface of a carbon substrate or member, that is, the liquid precursor has affinity between a liquid and a surface translating into the ability of the liquid to spread on the surface of the substrate.

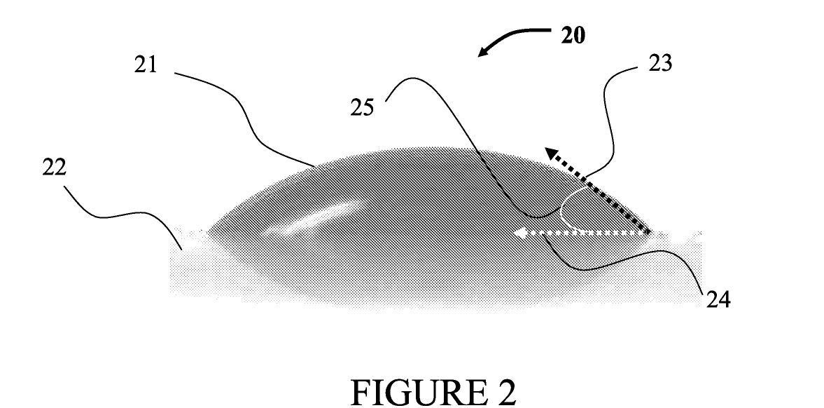

For example, in one embodiment with reference to FIG. 2, there is shown a photograph of a droplet of the curable liquid carbon precursor composition of the present invention reposed on top of a surface of a substrate, generally indicated by numeral 20, including a droplet of the curable liquid carbon precursor composition 21 of the present invention which has been placed on a flat surface of a substrate 22 such as a graphite substrate at ambient temperature (about 25° C.) to illustrate the wettability of the liquid droplet 21. The contact angle of the droplet is shown by the arrows 23 and 24 and angle 25. As known in the art, the lesser the angle 25, the better the wetting of the substrate surface 22 by the liquid droplet 21.

Generally, the wetting ability, i.e. the wettability, of the curable liquid carbon precursor composition in terms of contact angle on the surface of a substrate, for example of the droplet shown in FIG. 2, can be a minimum of less than 90 degrees, preferably from zero degrees to 90 degrees, more preferably from 5 degrees to 90 degrees, even more preferably from 10 degrees to 60 degrees, and most preferably from 15 degrees to 40 degrees at ambient temperature as measured on the surface of a substrate or a fiber in accordance to the method disclosed in ASTM Method D5725-99. In other embodiments, the contact angle of the curable liquid carbon precursor composition prior to curing can include 0 degrees or greater, 5 degrees or greater, 10 degrees or greater, or 15 degrees or greater. In other embodiments, the contact angle of the curable liquid carbon precursor composition prior to curing can include 90 degrees or lower, 60 degrees or lower, or 40 degrees or lower.

The substrates used in the present invention in which a contact angle may be measured with reference to the liquid composition can vary and may include for example graphite, glass, ceramic, and metals.

The process of the present invention includes curing the aforementioned curable liquid carbon precursor composition to form a cured material or cured product. The curing of the curable liquid carbon precursor composition may be carried out at a predetermined temperature and for a predetermined period of time sufficient to cure the liquid carbon precursor composition. For example, the temperature of curing the curable liquid carbon precursor composition or formulation may be generally from 10° C. to 350° C. in one embodiment; from 25° C. to 200° C. in another embodiment, from 100° C. to 190° C. in still another embodiment; and from 125° C. to 175° C. in yet another embodiment. In other embodiments, the temperature of curing can include 10° C. or greater, 25° C. or greater, 100° C. or greater, or 125° C. or greater. In other embodiments, the temperature of curing can include 350° C. or lower, 200° C. or lower, 190° C. or lower, or 175° C. or lower.

Generally, the curing time for curing the curable liquid carbon precursor composition or formulation may be chosen between 1 minute to 90 days in one embodiment, 2 minutes to 7 days, 3 minutes to 1 day, 5 minutes to 8 hours, to between 7 minutes to 4 hours in another embodiment, and between 10 minutes to 2 hours in still another embodiment. In other embodiments, the time of curing can include 1 minute or greater, 2 minutes or greater, 3 minutes or greater, 5 minutes or greater, 7 minutes or greater, or 10 minutes or greater. In other embodiments, the time of curing can include 90 days or lower, 7 days or lower 1 day or lower, 8 hours or lower, 4 hours or lower, or 2 hours or lower.

The divinylarene dioxide of the present invention such as DVBDO, which is one embodiment of the epoxy resin component of the curable composition of the present invention, may be used as the sole resin to form the epoxy matrix in the final curable liquid carbon precursor composition or formulation; or the divinylarene dioxide resin may be used in combination with another epoxy resin that is different from the divinylarene dioxide as the epoxy component in the final curable liquid carbon precursor composition or formulation.

Upon curing the curable liquid carbon precursor composition having a neat viscosity of less than 10,000 mPa-s at 25° C., the resultant cured composition is adapted for being carbonized or further processed. Upon curing the curable liquid carbon precursor composition, the cured composition comprises a solid body which can be formed or shaped into a desired preform structure before carbonizing the structure.

One of the beneficial consequences of producing the cured material from curing the curable liquid carbon precursor composition described above includes producing a cured product having a carbon yield of generally at least 35 wt % as measured in the absence of optional components. For example, the carbon yield of the cured product, as measured by thermogravimetric analysis (TGA), generally may be from 35 wt % to 95 wt % in one embodiment, from 40 wt % to 90 wt % in another embodiment, from 45 wt % to 85 wt % in still another embodiment, or from 50 wt % to 80 wt % in yet another embodiment, based on the total weight of the cured composition. In other embodiments, the carbon yield of the cured product can include 35 wt % or greater, 40 wt % or greater, 45 wt % or greater, or 50 wt % or greater. In other embodiments, the carbon yield of the cured product can include 95 wt % or lower, 90 wt % or lower, 85 wt % or lower, or 80 wt % or lower.

The resulting cured material (i.e., the cross-linked product) produced from curing the curable liquid carbon precursor composition described above forms a cured preform precursor that can be carbonized in accordance with the present invention to further form a carbonized composition or carbonized product with several improved properties over conventional epoxy resins which have been cured and carbonized.

In one embodiment, the curing step described above can be carried out concurrently with the carbonizing step in whole or in part. In another embodiment, the carbonizing step can be carried out as a separate step from the curing step.

For example, the process of the present invention can include the step of carbonizing the cured material in an inert atmosphere such as nitrogen or vacuum at a predetermined temperature and for a predetermined period of time sufficient to carbonize the cured material and provide a carbonized composition having a carbon yield of greater than 35 wt %. For example, the temperature of carbonizing the cured material may be generally from 350° C. to 4,000° C. in one embodiment; from 400° C. to 3,500° C. in another embodiment; from 500° C. to 3,000° C. in still another embodiment; and from 800° C. to 2000° C. in yet another embodiment.

Generally, the time of carbonizing the cured material may depend on the amount of carbon material, the size of the carbon article, and the complexity of the carbon article. In one illustrative embodiment, the time of carbonizing the cured material can be chosen for example in the range from 1 minute to 90 days in one embodiment, from 30 minutes to 7 days in another embodiment, and from 1 hour to 24 hours in still another embodiment.

Carbonizing the cured material as described herein above provides a carbonized composition or carbonized product having several advantages over the prior art. For example, one advantage of the carbonized composition of the present invention is that the carbonized composition has a low amount of impurities. The impurities can include for example metals and non-metals. The presence of impurities in the carbonized composition may introduce deleterious effects in the properties of the resulting carbonized material in its various applications and therefore the impurities in the carbonized product should be avoided.

In one embodiment, the curable liquid composition precursor of the present invention may be cured and carbonized to form a carbonized preform material for subsequent use in various enduses. In another embodiment, the curable liquid composition precursor of the present invention may be used as an epoxy adhesive for example by applying the liquid composition to a substrate; and then curing and/or carbonizing to form a preform material for subsequent use in various enduses.

For example, a carbonized material of the present invention may be used in composites for aerospace applications, electronic applications, and high temperature processes. For example, carbonized end products that employ a carbonized product of the present invention can include fuel cells, heat exchangers, carbon fibers, needle coke, graphite anodes and structural conductive carbon-carbon composite articles or parts.

### Examples

The following examples and comparative examples further illustrate the present invention in detail but are not to be construed to limit the scope thereof.

Various terms and designations used in the following examples are explained herein as follows:

“DVBDO” stands for divinylbenzene dioxide.

“MPTS” stands for methyl p-toluenesulfonate.

“EPTS” stands for ethyl p-toluenesulfonate.

“MMS” stands for methyl methanesulfonate.

“DDS” stands for 4,4-diaminodiphenylsulfone.

“TGA” stands for thermogravimetric analysis.

CYCAT® 600 is dodecylbenzenesulfonic acid (70 wt % in isopropanol) and is commercially available from Cytec.

ReziCure® 3000 is a phenol formaldehyde novolak resin aromatic curing agent commercially available from SI Group, Inc.

The following standard analytical equipments and methods are used in the Examples:

Measurement of Viscosities of the Precursor Composition

The viscosity of the curable liquid carbon precursor formulation of the present invention was measured on a torsional rheometer TA Instruments AR2000 equipped with a 50 mm diameter smooth stainless steel upper plate and a bottom Peltier plate assembly controlling both the temperature of the liquid sample and the normal force acting on Peltier plate surface About 2 mL of the formulation was deposited on the bottom plate before the top plate was lowered onto the liquid formulation until a gap of 300 microns between the two plates was achieved. The top plate was then rotated at a nominal rate of 0.001 rad/s while the temperature of the bottom plate was raised from 25° C. to 65° C. at a rate of 10° C./minute. Viscosity was automatically calculated by the TA software and reported as a function of the temperature.

Measurement of Contact Angle of the Liquid Droplet

Measurement of the contact angle of a liquid sample first requires measurement of the surface tension of the liquid. A Calm Dynamic Contact Angle Analyzer was used to measure the surface tension of the liquid. A “Wilhelmy glass plate” cleaned five times with an oxidizing blue flame of a propane torch was used. The method used was the “Read Weight/Time until Weight Stable” step at the ZDOI (Zero Depth Of Immersion) position. The attractive force of the liquid onto the Wilhelmy glass plate was automatically translated by the Cahn software as a surface tension value.

The Cahn Dynamic Contact Angle Analyzer was also used to measure contact in a second configuration where a droplet of the liquid was deposited on a substrate and the contact angle of the liquid droplet on the substrate was automatically computed during a lapse of 200 seconds. The angle is defined as the angular gap between the plane and the tangent to the edge of the drop of liquid formulation.

Measurement of Carbon Yield:

Carbon yield (% C) was determined by thermogravimetric analysis under nitrogen using a TA Instruments Q5000 Thermogravimetric Analyzer with a temperature ramp of 10° C./minute from 25° C. to 1,000° C. The “% C” is defined as the wt % residue of carbon at the completion of the above analysis.

### Examples 1-6 and Comparative Examples A and B

The components of the formulations shown in Table I were combined to form homogeneous solutions, cured in an aluminum pan or mold in an air recirculating oven using the indicated cure schedule, and carbonized by TGA. In Example 3, the components were heated to 120° C. to form a homogeneous solution prior to curing, cooled to 100° C., and poured into a mold preheated to 100° C. Upon cooling to 25° C. this mixture became a slurry.

TABLE I

| | Epoxy | | Curing Agent | | Catalyst | | | η | Cure | % C |
|---|---|---|---|---|---|---|---|---|---|---|
| Example | type | (g) | type | (g) | type | (g) | r | (mPa-s) | Schedule⁽¹⁾ | (wt. %) |
| Ex. 1 | DVBDO | 4.50 | p-cresol | 0.67 | MPTS | 0.05 | 3.0 | 12 | a | 62.13 |
| Ex. 2 | DVBDO | 4.53 | p-cresol | 0.66 | EPTS | 0.13 | 3.0 | 10 | b | 66.68 |
| Ex. 3 | DVBDO | 200.0 | DDS | 153.1 | | | 1.0 | 1300 | c | 56.87 |
| Ex. 4 | DVBDO | 5.00 | | | Cycat | 0.01 | | 13 | d | 56.17 |
| | | | | | 600 | | | | | |
| Ex. 5 | DVBDO | 5.00 | | | MPTS | 0.01 | | 12 | d | 59.61 |
| Ex. 6 | DVBDO | 5.00 | | | MMS | 0.01 | | 12 | d | 43.79 |
| Comp. | DVBDO | 160.0. | ReziCure | 209.4 | 1B2MZ | 7.40 | 1.0 | 11,600 | e | 36.2 |
| A | | | 3000 | | | | | | | |
| Comp. | DVBDO | 200.0 | ReziCure | 130.9 | 1B2MZ | 6.65 | 2.0 | 120,000 | e | 36.4 |
| B | | | 3000 | | | | | | | |
| Comp. | DEN438 | 20.0 | DDS | 6.89 | | | 1.0 | Solid⁽²⁾ | f | 30.8 |
| C | | | | | | | | | | |
| Comp. | DVBDO | 2.00 | CHTP | 2.09 | 1B2MZ | 0.082 | 1.50 | Solid⁽²⁾ | g | 20.4 |
| D | | | | | | | | | | |

⁽¹⁾The cure schedules indicated in Table I above are as follows:
a. 15 minutes each at 60° C. and 80° C., 30 minutes at 100° C., and 15 minutes each at 110° C., 120° C., 130° C., 140° C., 150° C., 160° C., 175° C., 200° C., and 220° C.
b. 30 minutes each at 60° C., 80° C., 90° C., 100° C., 105° C., 110° C., 115° C., 120° C., and 150° C., and 60° C. minutes each at 200° C. and 225° C.
c. 60 minutes at 120° C., and 30 minutes each at 160° C., 200° C., 240° C., 260° C., and 280° C.
d. 30 minutes each at 60° C., 70° C., 80° C., 90° C., 100° C., 105° C., 110° C., 115° C., 120° C., 120° C., and 150° C.
e. 60 minutes at 80° C., 30 minutes at 100° C., and 90 minutes at 200° C.
f. Procedure was modified for this plaque fabrication. Added DEN 438 and DDS to a round bottom flask, heated to 120° C. slowly. After DDS had completely dissolved, placed solution under vacuum to degas (5 mmHg) and cool slowly to 100° C. Poured into pre-heated (100° C.) mold and placed mold in preheated oven for 120 minutes at 220° C.
g. Melted CHTP at about 160° C., then added DVBDO and mixed. Allowed to cool until still fluid. Added catalyst, mixed for about 15 seconds, and then poured into pan and heated at 250° C. for 30 minutes.
⁽²⁾This composition became a solid at 25° C. and the viscosity was not measured.

FIG. 1 is a graphical representation of the weight variation of a cured carbon precursor formulation with an initial weight represented as 100% on the y-axis and typically situated between 10 mg and 20 mg. FIG. 1 shows that as temperature increases from 25° C. to 1,000° C. at a rate of 10° C./minute, the relative weight of the cured carbon precursor composition decreases until relative weight reaches the carbon yield of the cured carbon precursor composition at the maximum temperature of 1,000° C. The formulations illustrated in FIG. 1 include the relative evolution of weight versus temperature of cured formulations of the present invention such as Example 1 (▾), Example 2 (⋄), and Example 3 (□), compared to cured formulations of the prior art for such as Comparative Example A (▴), Comparative Example C (⋄), and Comparative Example D () as described in Table I above.

1. A curable liquid carbon precursor composition comprising (a) at least one aromatic epoxy resin; and (b)(i) at least one aromatic co-reactive curing agent, (b)(ii) at least one catalytic curing agent, or (b)(iii) a mixture thereof; wherein the liquid precursor composition has a neat viscosity of less than 10,000 mPa-s at 25° C. prior to adding optional components, prior to curing, and prior to carbonizing; and wherein the liquid precursor composition being cured has a carbon yield of at least 35 weight percent as measured in the absence of optional components.

2. The composition of claim 1, wherein the carbon yield of the composition comprises from 35 weight percent to 95 weight percent.

3. The composition of claim 1, wherein the composition comprises a solvent-free composition.

4. The composition of claim 1, wherein the neat viscosity of the composition comprises from 1 mPa-s to 10,000 mPa-s, at 25° C.

5. The composition of claim 1, wherein the aromatic epoxy resin comprises a divinylarene dioxide; and wherein the divinylarene dioxide comprises divinylbenzene dioxide.

6. The composition of claim 1, wherein the curing agent comprises a phenolic compound; and wherein the phenolic compound comprises a monophenol, a diphenol, a polyphenol, or mixtures thereof.

7. The composition of claim 6, wherein the monophenol comprises p-cresol.

8. The composition of claim 1, including (c) at least one curing catalyst.

9. The composition of claim 1, including an additional epoxy resin different from the aromatic epoxy resin, an additional curing agent different from the aromatic co-reactive curing agent and the catalytic curing agent, a filler, a reactive diluent, a flexibilizing agent, a processing aide, a toughening agent, or a mixture thereof.

10. A process for preparing a liquid carbon precursor composition comprising admixing (a) at least one aromatic epoxy resin; and (b)(i) at least one aromatic co-reactive curing agent, or (b)(ii) at least one catalytic curing agent, or (b)(iii) a mixture thereof; wherein the liquid precursor composition has a neat viscosity of less than 10,000 mPa-s at 25° C. prior to adding optional components, prior to curing, and prior to carbonizing; and wherein the liquid precursor composition being cured has a carbon yield of at least 35 weight percent as measured in the absence of optional components.

11. A cured liquid carbon precursor composition comprising a reaction product of curing a curable liquid carbon precursor formulation including (a) at least one aromatic epoxy resin; and (b)(i) at least one aromatic co-reactive curing agent, (b)(ii) at least one catalytic curing agent, or (b)(iii) a mixture thereof; wherein the liquid precursor composition has a neat viscosity of less than 10,000 mPa-s at 25° C. prior to adding optional components, prior to curing, and prior to carbonizing; and wherein the cured composition has a carbon yield of at least 35 weight percent as measured in the absence of optional components.

12. A process for preparing a cured liquid carbon precursor composition comprising curing a curable liquid carbon precursor formulation including (a) at least one aromatic epoxy resin; and (b)(i) at least one aromatic co-reactive curing agent, (b)(ii) at least one catalytic curing agent, or (b)(iii) a mixture thereof; wherein the liquid precursor formulation has a neat viscosity of less than 10,000 mPa-s at 25° C. prior to adding optional components, prior to curing, and prior to carbonizing; and wherein the cured composition has a carbon yield of at least 35 weight percent as measured in the absence of optional components.

13. A process for preparing a carbonized product comprising the steps of:
(I) admixing (a) at least one aromatic epoxy resin; and (b)(i) at least one aromatic co-reactive curing agent, or (b)(ii) at least one catalytic curing agent, or (b)(iii) a mixture thereof to form a liquid composition; wherein the liquid precursor composition has a neat viscosity of less than 10,000 mPa-s at 25° C. prior to adding optional components, prior to curing, and prior to carbonizing; and wherein the liquid precursor composition being cured has a carbon yield of at least 35 weight percent as measured in the absence of optional components;
(II) curing the liquid composition from step (I) to form a cured product; wherein the cured composition has a carbon yield of at least 35 weight percent as measured in the absence of optional components; and
(III) carbonizing the cured product from step (II) to form a carbonized composition.

14. The process of claim 13, wherein the process is carried out in the absence of a solvent.

15. The process of claim 13, wherein admixing step (I) is carried out at a temperature of from −10° C. to 100° C.; wherein the curing step (II) is carried out at a temperature of from 10° C. to 350° C.; and wherein the carbonizing step (III) is carried out at a temperature of from 350° C. to 4,000° C.

16. A carbonized composition prepared by the process of claim 13.
